(19) United States
(12) Patent Application Publication
(10) Pub. No.: US 2011/0126628 A1
(43) Pub. Date: Jun. 2, 2011

(54) NON-DESTRUCTIVE ULTRASOUND INSPECTION WITH COUPLING CHECK

(76) Inventors: York Oberdorfer, (US); Stephan Falter, (US); Ulrich Semmier, (US); Olaf Schroeder, (US)

(21) Appl. No.: 12/964,190

(22) Filed: Dec. 9, 2010

Related U.S. Application Data
(63) Continuation of application No. PCT/EP2009/057082, filed on Jun. 9, 2009.

(30) Foreign Application Priority Data
Jun. 9, 2008 (DE) 10 2008 027 384.8

(51) Int. Cl. G01N 29/28

(52) U.S. Cl. 73/644

(57) ABSTRACT

A method for non-destructive ultrasonic testing of a test piece includes a plurality of testing cycles, each of said cycles comprising a transmitting of at least one ultrasonic impulse into the test piece by a plurality of ultrasonic transducers and a receiving of the at least one ultrasonic impulse passing through the test piece by the ultrasonic transducer or optionally by other ultrasonic transducers. The plurality of ultrasonic transducers are phase-controllable and form at least one phase array. The method comprises at least one first testing cycle in which the phase-controllable ultrasonic transducers of the at least one phase array are controlled during transmitting such that the rear wall echo of the test piece is detected by said phase array during receipt. The method comprises at least one second testing cycle in which the phase-controllable ultrasonic transducer of the same phase array are controlled during transmitting.

### CROSS-REFERENCE TO RELATED APPLICATIONS

This patent application is a continuation of International Patent Application No. PCT/EP2009/057082, filed Jun. 9, 2009, and claims priority to German Patent Application No. DE 10 2008 027 384.8, filed Jun. 9, 2008. The disclosure of both of these applications is hereby expressly incorporated by reference as part of the present disclosure as if fully set forth herein.

### FIELD OF THE INVENTION

The invention relates to a method and an associated device for the non-destructive ultrasound inspection of a test piece, preferably a rod or a pipe, wherein the method comprises several test cycles, each of which includes a transmission of an ultrasonic pulse into the test piece by means of several ultrasonic transducers and a reception of the ultrasonic pulse passing the test piece by the transmitting, or optionally further, ultrasonic transducers.

### BACKGROUND OF THE INVENTION

Ultrasound testing is a suitable testing method for finding internal and external flaws in sound-conducting materials (to which most metals belong), for example in welding seams, steel forgings, casting, semi-finished products or pipes. Like all testing methods, ultrasound inspection is also standardized and is carried out in accordance with guidelines, such as according to DIN EN 10228-3 1998-07 “Zerstörungsfreie Prüfung von Schmiedestücken aus Stahl—Teil 3: Ultraschallprüfung von Schmiedestücken aus ferritischem and martensitischem Stahl” (“Non-destructive testing of steel forgings—Part 3: Ultrasonic testing of ferritic or martensitic steel forgings”), which is hereby incorporated by reference. Suitable testing devices and methods are known for the non-destructive testing of a test piece by means of ultrasound. General reference is made to the textbook by J. and. H. Krautkrämer ISBN, Werkstoffprüfung mit Ultraschall (Ultrasound material testing), sixth edition.

This method is generally based on the reflection of sound on boundary surfaces. The sound source most frequently used is a test probe with one or two ultrasonic transducers whose sound emission is in each case in the frequency range of 10 kHz to 100 MHz. In the case of the pulse-echo method, the ultrasonic probe does not emit a continuous radiation, but very short sound pulses with a duration of 1 μs and less. The pulse emanating from the transmitter passes through the test piece to be inspected with the respective speed of sound, and is almost completely reflected at the metal-air boundary surface. The sound transducer is mostly not only able to transmit pulses, but also to convert incoming pulses into electrical measuring signals; it thus also works as a receiver. The time required by the sound pulse to travel from the transmitter through the work piece and back again is measured with an oscilloscope or a computer unit. Given a known speed of sound c in the material, the thickness of a sample can thus be checked, for example. A couplant (e.g. a glue (solution), gel, water or oil) is applied onto the surface of the workpiece to be inspected and the ultrasonic transducer in order to couple them. In the case of a relative movement between the transducer and the test piece, the test piece is often immersed in a suitable liquid (immersion technique) or wetted in a defined manner for the purpose of transmitting the sound signal.

Due to changes in the acoustic properties on boundary surfaces, i.e. at the external wall surfaces delimiting the test piece, but also at the internal boundary surfaces, i.e. internal flaws such as piping (cavity), on a pocket, on a lamination, on a tear or on another interruption in the structure within the workpiece to be inspected, the sound pulse is reflected and transmitted back to the transducer in the test probe which acts both as a transmitter as well as a receiver. The time that has passed between the transmission and the receipt makes it possible to calculate the distance. Using the measured difference in time, a signal image is generated and made visible on a monitor or oscilloscope. Using this image, the position of the change of the acoustical properties in the test piece can be determined and the size of the flaw (which in the technical jargon is referred to as “discontinuity”) can be estimated, if necessary. In the case of automatic testing plants, the information is stored, put in relation to the test piece, and documented immediately or later in various manners.

In the methods for non-destructive ultrasound inspection of a test piece, it is of utmost importance to provide for good coupling of the ultrasonic transducers and monitor it in order to achieve and maintain a high quality of the material testing. Therefore, an ultrasonic transducer which transmits into the test piece in such a way that an associated back-face echo is received by it is used in known systems. The coupling quality can be determined by its strength, for example by the attenuation relative to the original signal. One or more further separate ultrasonic transducers serve for transmitting the actual measuring ultrasound. These additional transducers generally are not designed for generating a back-face echo. This test probe structure is disadvantageous in that a conclusion has to be drawn as to the quality of the coupling of the other transducers based on only a single coupling measurement of a transducer. This leads to an increased unreliability of the measurement. In another known designs, one ultrasonic transducer required for testing the coupling and one additional ultrasonic transducer, respectively, for each further transmission direction are integrated into a test probe. This leads to the respective test probe becoming relatively large and to the geometry of the test probe having to be adapted for every surface shape of a test piece, due to the multitude of ultrasonic transducers. This complicates carrying out the ultrasound inspection and makes it more expensive.

### SUMMARY OF THE INVENTION

In view of the above-described drawbacks it is therefore an object of the invention to provide a method and an associated device for the non-destructive ultrasound inspection of a test piece which is able to detect a discontinuity less expensively and/or with a higher accuracy.

The method according to the invention for the non-destructive ultrasound inspection comprises several test cycles, each of which includes a transmission of at least one ultrasonic pulse into the test piece by several ultrasonic transducers and a reception of the at least one ultrasonic pulse passing the test piece by the transmitting, or optionally further, ultrasonic transducers. The method according to the invention is characterized in that the several ultrasonic transducers are separately controllable in a phase-accurate manner and form at least one phased array; such phased arrays are also referred to as phased array test probes. A phased array typically comprises 16, 32, 64, 128 or 256, preferably 16, individual transducers which are accommodated in a linear arrangement in a housing and connected with a corresponding number of optionally miniaturized electronic transmitter-preamplifier systems. In this manner, the individual oscillator elements can be excited in a time-controlled, that is phase-accurate and optionally phase-shifted manner, in order to thus turn the sound field in a certain direction and/or focus it in a certain depth.

The method according to the invention comprises at least one first test cycle in which, during transmission, the phase-controllable ultrasonic transducers of the at least one phased array are controlled in such a manner that the back-face echo of the test piece is acquired by this phased array during reception. Using this back-face echo, which as a rule is received by the same phased array that has transmitted the pulse, the quality of the coupling between the phased array and the relevant surface section of the test piece can be acquired and assessed by means of its attenuation when passing the test piece while being reflected on the back face. Because of the limiting faces of the test piece most frequently being parallel, a primary propagation direction of the transmitted ultrasonic pulse in the first test cycle is preferably oriented perpendicularly to the surface of the test piece facing the respective phased array.

Moreover, the inventors found that a measurement by means of back-face echoes not only permits the determination of the coupling quality, but that it provides the capability of detecting so-called laminations in the test piece with a high degree of reliability. Lamination refers to a flaw in the rolled steel in the shape of a split in the material. It is produced by cavities in the cast semi-finished product, in particular by piping, and is highly relevant with regard to safety.

The method according to the invention is further characterized by comprising at least one second test cycle in which, during transmission, the phase-controllable ultrasonic transducers are controlled in such a manner that a primary propagation direction of the transmitted ultrasonic pulse into the test piece is achieved which is different from that of the first test cycle, in order to determine further flaws in the region of the test piece adjacent to the test probe. Due to the changed primary propagation direction, there is as a rule no detection of back-face echoes. The person skilled in the art is responsible for selecting with few tests a specific phase control adapted to the geometry of the test piece in order to obtain a suitable primary propagation direction of the associated ultrasonic pulse directed in the direction of the desired area to be inspected of the test piece.

The use of phase-controllable phased arrays is not only advantageous in that it does not require any specific alignment of the transducer or of its leading portion due to being phase-controllable. Adaptation to the geometry of the test piece can be easily carried out by means of the phase control to the geometry of the test piece. Rather, it has the additional advantage that the first test cycle and the second test cycle can be carried out by the same phased array or arrays. The test assembly is thus simplified considerably. The test probe, which in this case comprises the phased array, can be made smaller so that the resolution can be increased. Moreover, the method can be carried out less expensively.

In a preferred embodiment, the method comprises several second test cycles with different primary propagation directions. The volume of the test piece to be tested for discontinuities is thereby enlarged, and possible flaws are exposed to sound under different angles, which leads to a signal maximization and thus to an increase of the accuracy of the method according to the invention.

Another embodiment provides that in the second test cycles several adjacent phased arrays transmit at the same time. Not only is the simultaneously inspected volume of the test piece increased and the procedure accelerated thereby, but the detection sensitivity can be made spatially more constant in a comparatively simple manner, and the areas low in sound between the adjacent phased arrays can be acquired with an increased sensitivity. A method in which groups of two adjacent phased arrays transmit at the same time in the respective test cycles is described in DE 198 13 414 B4, which is hereby incorporated by reference.

According to another advantageous embodiment, a relative movement, for example a rotation and/or longitudinal displacement, between the test piece and the at least one phased array, for example simultaneously with carrying out the test cycles or intermittently, is provided for an acquisition and inspection of the test piece that is as complete as possible.

The method according to the invention for the non-destructive ultrasound inspection is particularly suitable for the inspection of a pipe or of a rod as a test piece by means of several phased arrays disposed along a surface in the longitudinal direction of the pipe or rod. As used herein the terms pipe and rod may be used interchangeably. In the process, one first test cycle, respectively, and at least one second test cycle is carried out in a clocked sequence by means of at least one phased array. In order to accomplish a very accurate and quick inspection, the first and the at least one second test cycle, preferably several second test cycles, are carried out in each clock cycle of the clocked sequence in each case by means of equal-number groups of several adjacent phased arrays.

Preferably, the sound fields of the several adjacent phased arrays spatially overlap in the first and/or second test cycle in two successive clock cycles, respectively, of the clocked sequence. It is thereby ensured that the detection sensitivity becomes more constant and the areas low in sound between the adjacent phased arrays can also be acquired with an increased sensitivity. A method in which, in successive clock cycles, the right-hand neighbor of a phased array transmits at one time, together with the phased array concerned, and in the next, the left-hand neighbor, is described in DE 198 13 414 B4 and is applied in one embodiment of the method according to the invention.

For an acquisition in the circumferential and longitudinal direction that is as complete as possible, the rod or pipe is fed forward and/or rotated relative to the phased arrays. The clock cycle is selected such that a longitudinal section of the rod or pipe moved in the longitudinal direction is inspected in each clock cycle by at least one phased array adjacent in the movement direction, or by an adjacent group, in a different circumferential position of the phased array or phased arrays, due to the rotation. It was found that a reliable detection of flaws can thus be achieved in the case of a rod or pipe. Preferably, the rotation and the forward feed are carried out simultaneously with the test cycles. The speed of the rotation and forward-feed is preferably selected such that the longitudinal section of the rod or pipe was completely acquired in the circumferential direction at least once, i.e. in the case of phased arrays arranged in a line, the rod or pipe is rotated about its longitudinal axis once during the movement along the path determined by the phased arrays.

The invention further relates to a device for the non-destructive ultrasound inspection of a test piece, the device comprising several ultrasonic transducers and a control and evaluation unit for carrying out and evaluating several test cycles. In this case, each test cycle includes a transmission of an ultrasonic pulse into the test piece by the several ultrasonic transducers and a reception of the ultrasonic pulse passing the test piece by the transmitting or further ultrasonic transducers. The device according to the invention is characterized by the several ultrasonic transducers being phase-controllable and forming at least one phased array, and the control and evaluation unit being designed such that, in at least one first test cycle, the phase-controllable ultrasonic transducers of the at least one phased array, while transmitting the ultrasonic pulse, are controlled such that the back-face echo of the test piece is acquired by the respective phased array during reception. In at least one second test cycle, the phase-controllable ultrasonic transducers of the same (at least one) phased array are controlled in such a way during transmission that a primary propagation direction of the transmitted ultrasonic pulse into the test piece is provided which is different from that of the first test cycle.

As was already explained above, the quality of the acoustic coupling of the phased arrays to the respective surface section of the test piece is acquired and assessed by means of the back-face echo generated in the first test cycle, that is, the ultrasonic pulse reflected on the back face of the test piece, more specifically by means of its attenuation when passing through the test piece while being reflected on the back face. Because of the limiting faces of the test piece most frequently being parallel, a primary propagation direction of the transmitted ultrasonic pulse in the first test cycle is preferably oriented perpendicularly to the surface of the test piece facing the respective phased array. Moreover, the inventors surprisingly found that a measurement using the back-face echo not only permits the determination of the coupling quality, but is particularly suitable also for the detection of laminations in the test piece and thus increases the reliability of the inspection.

As was already mentioned, the method according to the invention is further characterized in that at least one second test cycle is carried out by means of the control and evaluation unit, in which, during transmission, the phase-controllable ultrasonic transducers are controlled in such a manner that a primary propagation direction of the transmitted ultrasonic pulse into the test piece is achieved which is different from that of the first test cycle, in order to determine further flaws in the region of the test piece surrounding the test probe. There is preferably no detection of the back-face echo in this primary propagation direction. The person skilled in the art is responsible for selecting with few tests a specific phase control adapted to the geometry of the test piece in order to obtain a suitable primary propagation direction of the associated ultrasonic pulse directed in the direction of the desired area to be inspected of the test piece.

The use of phased arrays that can be controlled in a phase-accurate manner is not only advantageous in that, due to being phase-controllable, it does not require any alignment specific to the test piece surface of the transducer or of its leading portion, that is, that due to the phase control this can be carried out quickly and individually depending on the geometry of the test piece. Rather, the result is the additional advantage that the first test cycle and the second test cycle can be carried out by the same phased array or arrays. The test assembly is thus simplified considerably. The virtual test probe, which in this case corresponds to the phased array, can be made smaller so that the resolution can be increased. On the whole, the non-destructive ultrasound inspection can be carried out less expensively and more reliably with the device according to the invention.

According to another advantageous embodiment of the device according to the invention, a means for the relative movement between the test piece and the at least one phased array is provided. Moreover, a positioning device is provided which mechanically fixes the position of the non-circular test piece relative to the at least one phased array. In this case, the positioning unit is preferably designed so as to be replaceable.

The invention further relates to the use of the device in one of the above-described embodiments for the non-destructive ultrasound inspection of a pipe or rod as a test piece.

The invention is illustrated below with reference to a few schematic figures without limiting the invention to the embodiment shown respectively.

### BRIEF DESCRIPTION OF THE DRAWINGS

Other objects and advantages of the present invention will become apparent in view of the following detailed description of the embodiments and the accompanying drawings, in which:

FIG. 1 is a schematic representation of a side view of a typical structure of a phased array used according to the invention with a plurality of individual ultrasonic transducers;

FIG. 2 is a schematic top view of an arrangement according to the invention of several phased arrays 1, 1′ . . . 1ⁿ along the longitudinal direction of a rod as a test piece;

FIG. 3a is a schematic illustration of a phased array showing the primary propagation direction of the ultrasonic pulse transmitted by the transducer using a first phase control;

FIG. 3a is a schematic illustration of a phased array showing the primary propagation direction of the ultrasonic pulse transmitted by the transducer using a second phase control; and

FIG. 4 is a schematic representation of a possible clock cycle.

### DETAILED DESCRIPTION OF EMBODIMENTS OF THE INVENTION

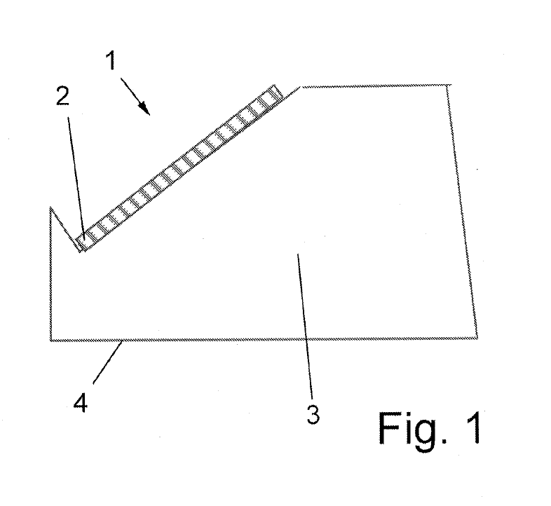

FIG. 1 schematically shows in a side view a typical structure of a phased array 1 used according to the invention with a plurality of individual ultrasonic transducers that can be controlled in a phase-accurate manner. The ultrasonic transducers 2 are disposed on a leading body 2 for coupling to the test piece 7 to be inspected. Depending on the desired transmission direction of the ultrasonic transducers 2, and depending on the shape of the surface of the test piece adjoining during the inspection, the leading body 3 can be designed to differ in the area of the contact surface 4 from the shape shown. The primary transmission direction can be changed to a certain extent by the selection of the phase shift between the ultrasonic pulses transmitted by the individual ultrasonic transducers 2. Thus, the phased array 1 can be used for carrying out the first and second test cycles.

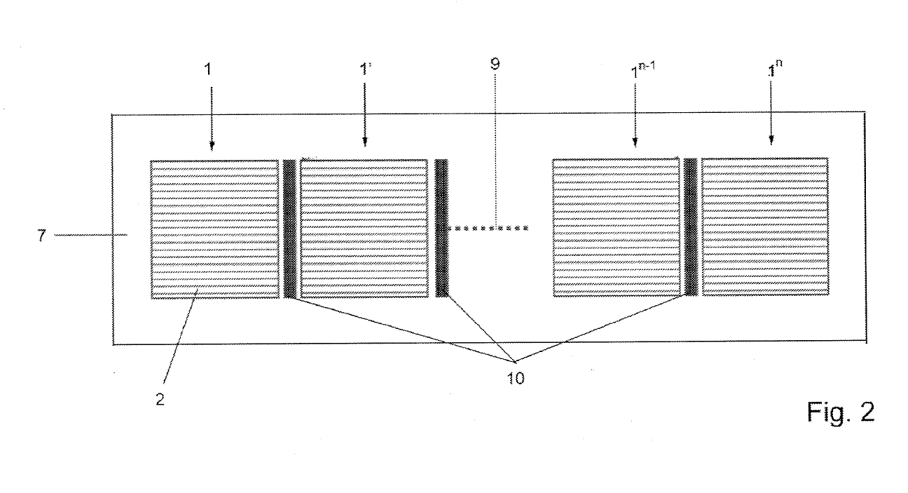

FIG. 2 shows in a schematic top view, by way of example, an arrangement according to the invention of several phased arrays 1, 1′ . . . 1ⁿ along the longitudinal direction 9 of a rod as a test piece, which are disposed adjacent to its surface. The ultrasonic transducers 2 of the respective phased array 1, 1′ . . . 1ⁿ are in this case disposed distributed in a direction perpendicular to the longitudinal direction 9, wherein 128 transducers are provided, for example, wherein 16 respectively form a phased array. The phase shift between the ultrasonic pulses transmitted by the ultrasonic transducers 2 enable pivoting the primary transmission direction in a plane that is perpendicular to the paper plane and to the longitudinal direction 9, which permits a comprehensive inspection of the test piece 7 in the solid angle areas that respectively adjoin the longitudinal axis 9. The phased arrays 1, 1′. . . 1ⁿ are respectively mutually decoupled by an electrical and acoustical cross-talk attenuation 10 in order not to mutually interfere with the reception.

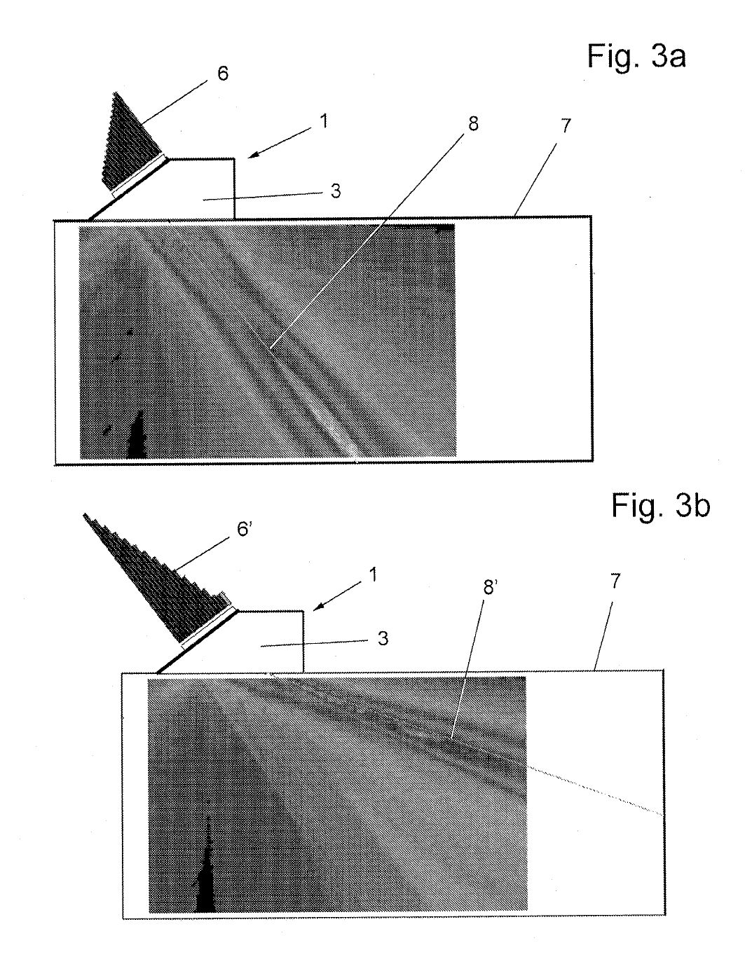

FIGS. 3a and 3b illustrate, with the phased array 1 shown in FIG. 1, how the primary propagation direction 8 and 8′, respectively, of the ultrasonic pulse transmitted by the ultrasonic transducer or the phased array 3, respectively, via the leading body 3 into the test piece 7 can be varied by means of the different phase controls 6 and 6′, respectively, in order to generate, for example, two test cycles with different primary propagation directions of the transmitted ultrasonic pulse.

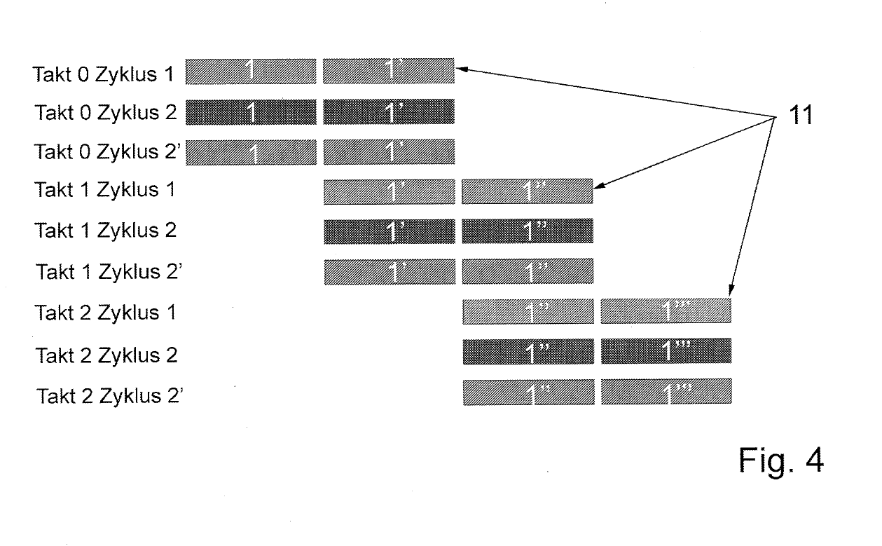

FIG. 4 shows a possible clock cycle of the method according to the invention. In the process, two phased arrays 1, 1′, 1″, 1′″, respectively, which lie next to one another in the longitudinal direction of the test piece, transmit an ultrasonic pulse in each clock cycle 0, 1, 2 with the three test cycles 1, 2, 2′ each, wherein the phase shift between the individual ultrasonic transducers can be, but need not be, selected differently. The clock cycles 0, 1, 2 respectively comprise a first test cycle 1 for the inspection of the test piece for lamination and for checking the coupling of the respective phased arrays to the test piece by means of a back-face echo, wherein the transmission takes place perpendicularly to the test piece surface adjacent to the phased array. In contrast, in the cycles 2 of each clock cycle, the ultrasonic transducers 2 of the respective phased arrays are controlled in such a phase-accurate manner that a lateral transmission in a solid angle 2 of the phased array concerned is accomplished. By changing the phase control, a transmission into another solid angle 2 by the respective phased arrays takes place in the cycles 2′ of each clock cycle. The detection sensitivity becomes more constant by the sound fields of successive clock cycles overlapping. Due to the overlap of sound fields of adjacent phased arrays, the areas low in sound between the adjacent phased arrays are acquired with an increased sensitivity. Due to the clock cycle, the sound field is displaced along the longitudinal direction of the test piece. At the same time, the test piece (a pipe or rod, for example) is displaced and rotated with the same longitudinal speed under the phased arrays, so that approximately the same longitudinal portion is acquired in each clock cycle, but under a different circumferential position of the phased arrays concerned, which thus emit sound into a different solid angle area of the test piece.

What is claimed is:

1. A method for the non-destructive ultrasound inspection of a test piece, comprises a plurality of test cycles, each of which includes a transmission of at least one ultrasonic pulse into the test piece by means of several ultrasonic transducers and a reception of the at least one ultrasonic pulse passing the test piece by the ultrasonic transducers;
wherein the several ultrasonic transducers are individually controllable in a phase-accurate manner and form at least one phased array;
wherein at least one relative movement between the test piece and the at least one phased array is carried out; and
wherein the plurality of test cycles comprise:
at least one first test cycle in which, during transmission, the phase-controllable ultrasonic transducers of the at least one phased array are controlled in such a manner that the back-face echo of the test piece is acquired by this phased array during reception; and
at least one second test cycle in which, during transmission, the phase-controllable ultrasonic transducers of the same at least one phased array are controlled in such a manner that a primary propagation direction of the transmitted ultrasonic pulse into the test piece is achieved which is different from that of the first test cycle;
wherein the quality of the coupling between the phased array and the respective surface section of the test piece is acquired and assessed by means of an attenuation of the back-face echo when passing the test piece.

2. The method for the non-destructive ultrasound inspection of claim 1, wherein the at least one relative movement comprises a rotation.

3. The method for the non-destructive ultrasound inspection of claim 1, wherein the at least one relative movement comprises a displacement.

4. The method for the non-destructive ultrasound inspection of claim 1, wherein in the first test cycle, a primary propagation direction of the transmitted ultrasonic pulse is oriented perpendicularly to the surface of the test piece facing the respective phased array.

5. The method for the non-destructive ultrasound inspection of claim 1, wherein the at least one second test cycle comprises several second test cycles with different primary propagation directions α2, α2′, . . . .

6. The method for the non-destructive ultrasound inspection of claim 3, wherein several adjacent phased arrays (1, 1′, 1′″) transmit simultaneously in order to achieve different primary propagation directions in the several second test cycles.

7. The method for the non-destructive ultrasound inspection of claim 3, wherein in a one of the at least one second test cycles, at least two adjacent phased arrays (1, 1′, 1′″) transmit simultaneously under the same phase control.

8. The method for the non-destructive ultrasound inspection of claim 1, wherein the test piece is a rod and the at least one phased array comprises several phased arrays (1 . . . 1ⁿ) arranged along a surface in the longitudinal direction of the rod, wherein the at least one first test cycle and the at least one second test cycle are carried out in a clocked sequence by means of at least one of the phased arrays (1 . . . 1ⁿ), respectively.

9. The method for the non-destructive ultrasound inspection of claim 1, wherein the at least one first test cycle and the at least one second test cycle are carried out in each clock cycle of the clocked sequence in each case by means of equal-number groups of at least two adjacent phased arrays.

10. The method for the non-destructive ultrasound inspection of claim 1, wherein the sound fields of at least two adjacent phased arrays spatially overlap in the first and/or second test cycle in two successive clock cycles, respectively, of the clocked sequence.

11. The method for the non-destructive ultrasound inspection of claim 1, wherein the test piece is a rod that is fed forward and rotated relative to the phased arrays and a clock cycle is selected such that a longitudinal section of the rod moved in the longitudinal direction is inspected in each clock cycle by at least one phased array adjacent in the movement direction, or by an adjacent group, in a different circumferential position of the phased array or phased arrays.

12. A device for the non-destructive ultrasound inspection of a test piece comprising:
several ultrasonic transducers that form at least one phased array and are controllable in a phase-accurate manner;
means for the relative movement between the test piece and the at least one phased array; and
a control and evaluation unit for carrying out and evaluating several test cycles, each of which includes a transmission of an ultrasonic pulse into the test piece by means of the several ultrasonic transducers and a reception of the ultrasonic pulse passing the test piece by the ultrasonic transducers;
wherein the control and evaluation unit is designed such that, in at least one first test cycle, the ultrasonic transducers of the at least one phased array that can be controlled in a phase-accurate manner, while transmitting the ultrasonic pulse, are controlled such that the back-face echo of the test piece is acquired by the respectively transmitting phased array during reception, and that in at least one second test cycle, the phase-controllable ultrasonic transducers of the same at least one phased array are controlled in such a way during transmission that a primary propagation direction of the transmitted ultrasonic pulse into the test piece is provided which is different from that of the first test cycle; and
wherein the control and evaluation unit is designed to acquire and assess the quality of the coupling between the phased array and the respective surface section of the test piece by means of an attenuation of the back-face echo when passing the test piece.

13. A device for the non-destructive ultrasound inspection of a test piece wherein the test piece is a pipe.

14. A device for the non-destructive ultrasound inspection of a test piece wherein the test piece is a rod.
